(19) United States
(12) Patent Application Publication
(10) Pub. No.: US 2016/0285734 A1
(43) Pub. Date: Sep. 29, 2016

(54) CLOUD-ENVIRONMENT PROVISION SYSTEM, ROUTE CONTROL METHOD, AND MEDIUM

(71) Applicant: NEC CORPORATION, Tokyo (JP)

(72) Inventor: Hiroshi DEMPO, Tokyo (JP)

(21) Appl. No.: 14/442,219

(22) PCT Filed: Nov. 20, 2013
(86) PCT No.: PCT/JP2013/081293

§ 371 Date: May 12, 2015

(30) Foreign Application Priority Data
Nov. 21, 2012 (JP) 2012-254945

(51) Int. Cl. H04L 12/751; H04L 12/911; H04L 29/08

(52) U.S. Cl. CPC H04L 45/02; H04L 67/10; H04L 47/70

(57) ABSTRACT

A cloud-environment provision system according to the present invention includes: resource managing unit that manages a resource arranged in a first cloud system, a resource arranged in a second cloud system, and a resource arranged between the first and second cloud systems; migration control unit that performs migration of transferring a virtual machine of a user operating on a machine in the first cloud system to a machine in the second cloud system; and route control unit that, after the migration is performed, changing a route of which destination or source is a virtual machine operating on the first cloud system to a route of which destination or source is a virtual machine operating on the second cloud system by controlling a communication node managed by the resource managing unit.

### TECHNICAL FIELD

1. Description of the Related Application

This application is based upon and claims the benefit of priority from Japanese patent application No. 2012-254945 (filed on Nov. 21, 2012), the disclosure of which is incorporated herein in its entirety by reference.

The present invention relates to a cloud-environment provision system, a service management device, a route control method, and a program, and, particularly, to a cloud-environment provision system, a service management device, a route control method, and a program, that provide a cloud environment for a user.

2. Background Art

The patent literature 1 discloses a technique in which a virtual machine operating on a host machine (physical server machine) connecting to a certain network is migrated to a host machine connecting to a different network. According to the technique described in the same patent literature, when migration of a virtual machine is started up, a tunnel is constructed between virtual routers operating on individual host machines, and data of the virtual machine is forwarded by using the tunnel. Then, it is supposed that after the migration is completed, a virtual router operating on the host of the migration destination performs updating of a route table on a neighboring outside router.

The patent literature 2 discloses a configuration with which a service executed in a certain cloud can be provided by using a resource of another cloud.

The non-patent literatures 1 and 2 disclose a network architecture called OpenFlow that is a type of centralized control of a physical switch. Because it is possible to perform fine control in a unit of flow, the OpenFlow can slice a physical network constituted of an OpenFlow switch by VLAN IDs or the like and provide a plurality of virtual networks. According to the OpenFlow, the physical switch can also be used as a virtual node on such a virtual network by a user.

### CITATION LIST

### Patent Literature

[PLT 1] Description of U.S. Patent Application Publication No. 2010/0287548

[PLT 2] Japanese Laid-open Patent Publication No. 2011-186637

### Non Patent Literature

[NPL 1] Nick McKeown, and seven others, “OpenFlow: Enabling Innovation in Campus Networks”, [online], [Searched on Sep. 25, 2012], Internet

<URL:http://www.openflow.org/documents/openflow-wp-latest.pdf>

[NPL 2] “OpenFlow Switch Specification” Version 1.1.0 Implemented (Wire Protocol 0x02), [online], [Searched on Sep. 25, 2012], Internet

<URL:http://www.openflow.org/documents/openflow-spec-v1.1.0.pdf>

### SUMMARY OF INVENTION

### Technical Problem

The following analysis is given by the present invention. A first problem of the above-described patent literature 1 is a point in that it takes time for route change processing due to VM migration. This is because an incident that the VM is moved is propagated by autonomous-route-table updating-operation of distributed existing routers, as described in the paragraph 0042 of the patent literature 1. For this reason, it is considered that at least a few minutes are required for completing the route change processing.

A second problem of the above-described patent literature 1 is a point in that a packet loss occurs. This is because it takes time for the above-described route table updating so that a packet routed based on old route information is routed to a network before VM migration. However, the VM to be the destination is already migrated so that a packet loss occurs.

In this regard, the patent literature 2 does not describe more than that a plurality of cloud systems are connected by an IP network (refer to paragraph 0016), and does not take into consideration that it takes time for the route change processing.

An object of the present invention is to provide a configuration that can contribute to reduction in time required for route change processing when migration of a virtual machine is performed between a plurality of cloud systems, and such a method and a program.

### Solution to Problem

According to a first standpoint, a cloud-environment provision system is provided. The cloud-environment provision system includes: resource managing means for managing a resource arranged in a first cloud system, a resource arranged in a second cloud system, and a resource arranged between the first and second cloud systems; migration control means for performing migration of transferring a virtual machine of a user operating on a machine in the first cloud system to a machine in the second cloud system; and route control means for, after the migration is performed, changing a route of which destination or source is a virtual machine operating on the first cloud system to a route of which destination or source is a virtual machine operating on the second cloud system by controlling a communication node managed by the resource managing means.

According to a second standpoint, a service management device is provided. The service management device includes: resource managing means for managing a resource arranged in a first cloud system, a resource arranged in a second cloud system, and a resource arranged between the first and second cloud systems; migration control means for performing migration of transferring a virtual machine of a user operating on a machine in the first cloud system to a machine in the second cloud system; and route control means for, after the migration is performed, changing a route of which destination or source is a virtual machine operating on the first cloud system to a route of which destination or source is a virtual machine operating on the second cloud system by controlling a communication node managed by the resource managing means.

According to a third standpoint, a route control method in a cloud-environment provision system is provided. The method is executed, by a service management device including: resource managing means for managing a resource arranged in a first cloud system, a resource arranged in a second cloud system, and a resource arranged between the first and second cloud systems. The method includes a step of performing migration of transferring a virtual machine of a user operating on a machine in the first cloud system to a machine in the second cloud system; and a step of changing a route of which destination or source is a virtual machine operating on the first cloud system to a route of which destination or source is a virtual machine operating on the second cloud system by controlling a communication node managed by the resource managing means. The method related with a specific machine such as the above-described service management device.

According to a fourth stand point, a program is provided. The program causes a computer constituting a service management device which includes: communication node managing means for managing a communication node arranged in a first cloud system, a communication node arranged in a second cloud system, and a communication node arranged between the first and second cloud systems, to perform: processing of performing migration of transferring a virtual machine of a user operating on a machine in the first cloud system to a machine in the second cloud system; and processing of changing a route of which destination or source is a virtual machine operating on the first cloud system to a route of which destination or source is a virtual machine operating on the second cloud system by controlling a communication node managed by the resource managing means. Further, the program can be stored in a computer readable (non-transitory) storage medium. Namely, the present invention can be provided as a computer program product.

### Advantageous Effects of Invention

According to the present invention, it is made possible to contribute to reduction in time required for route change processing when migration of a virtual machine is performed between plural cloud systems.

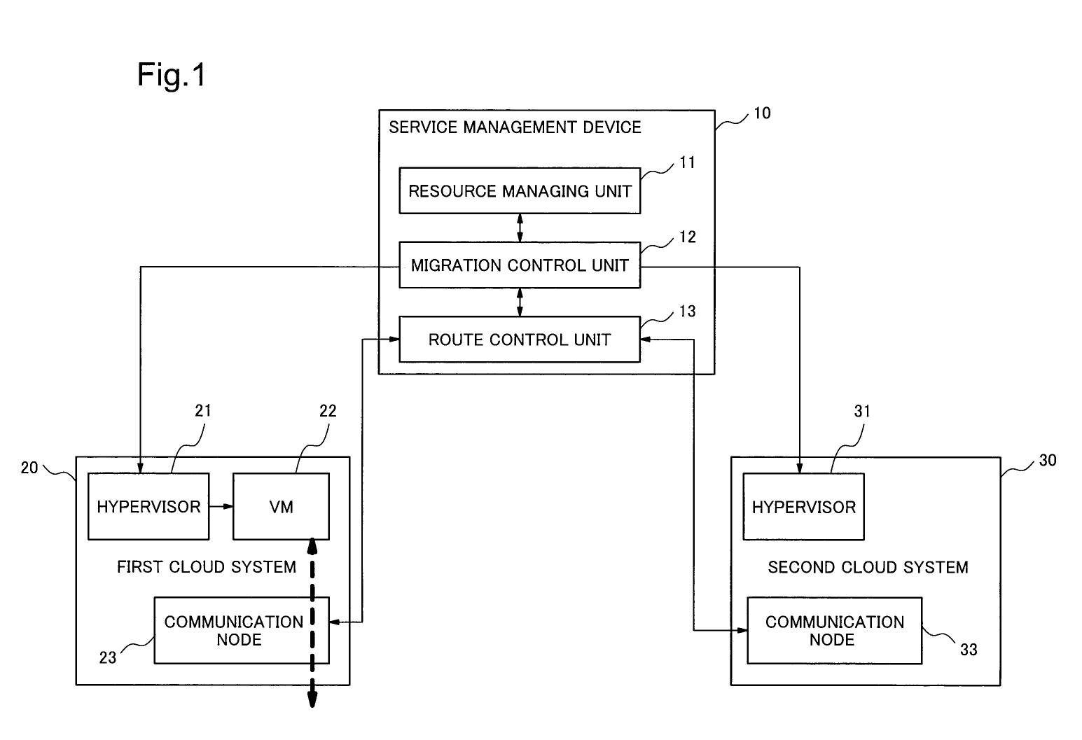

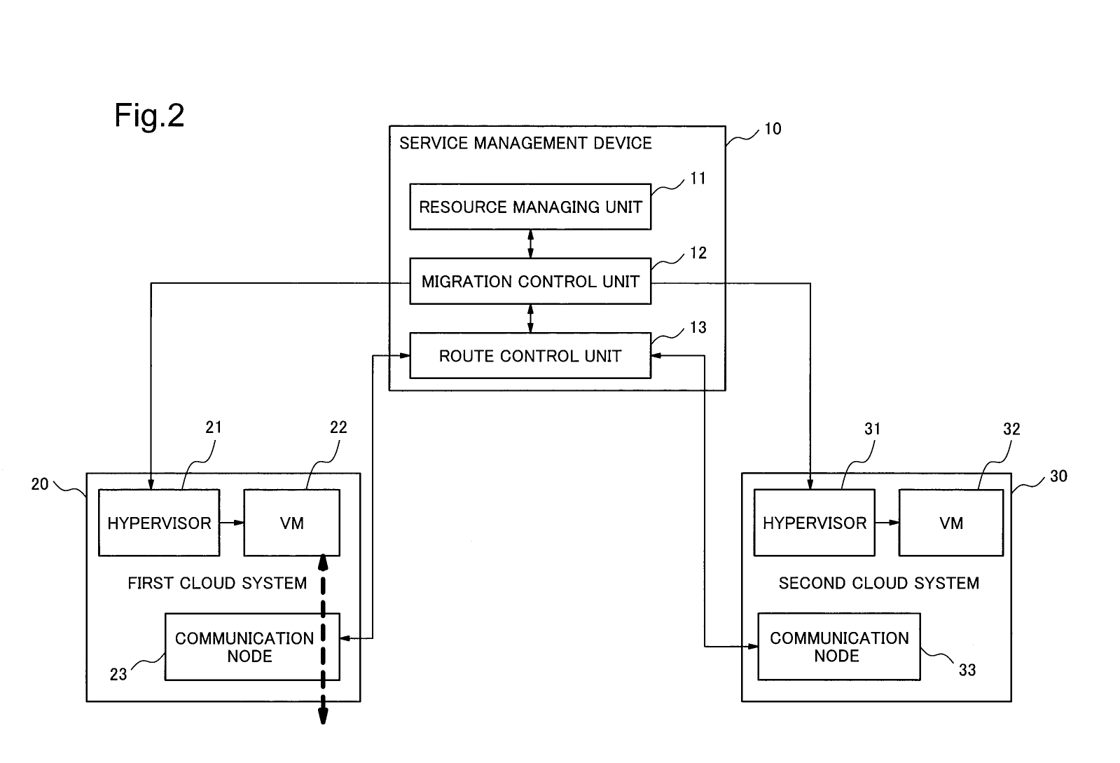

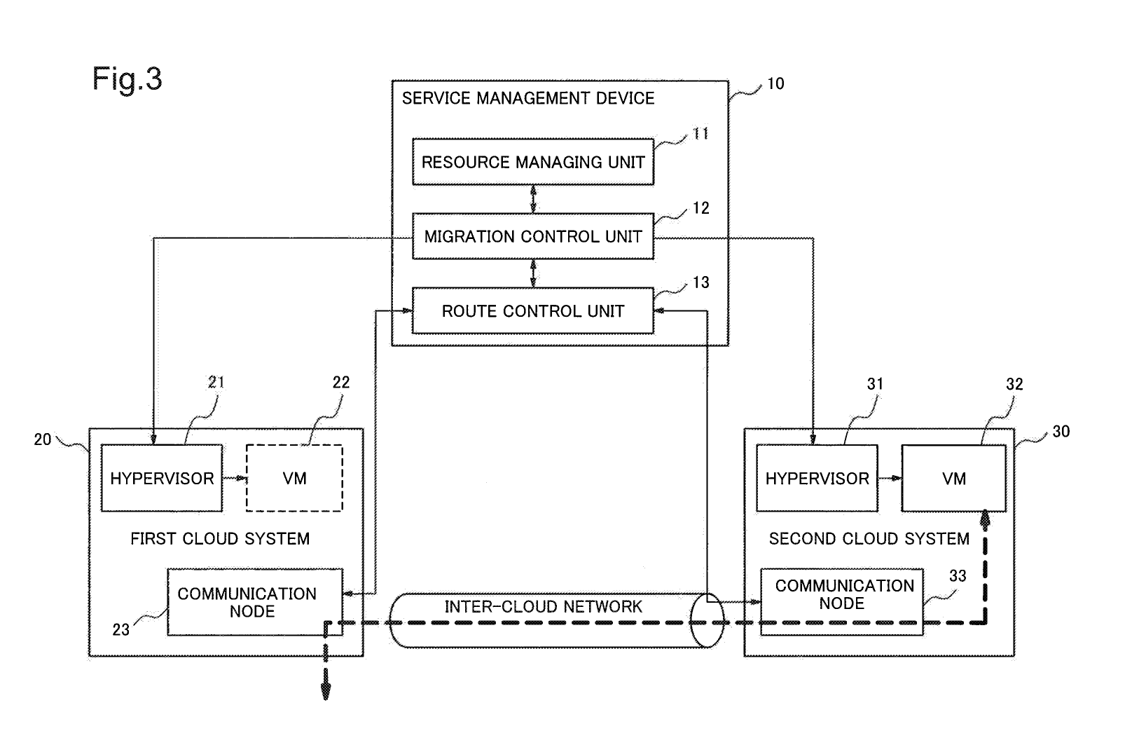

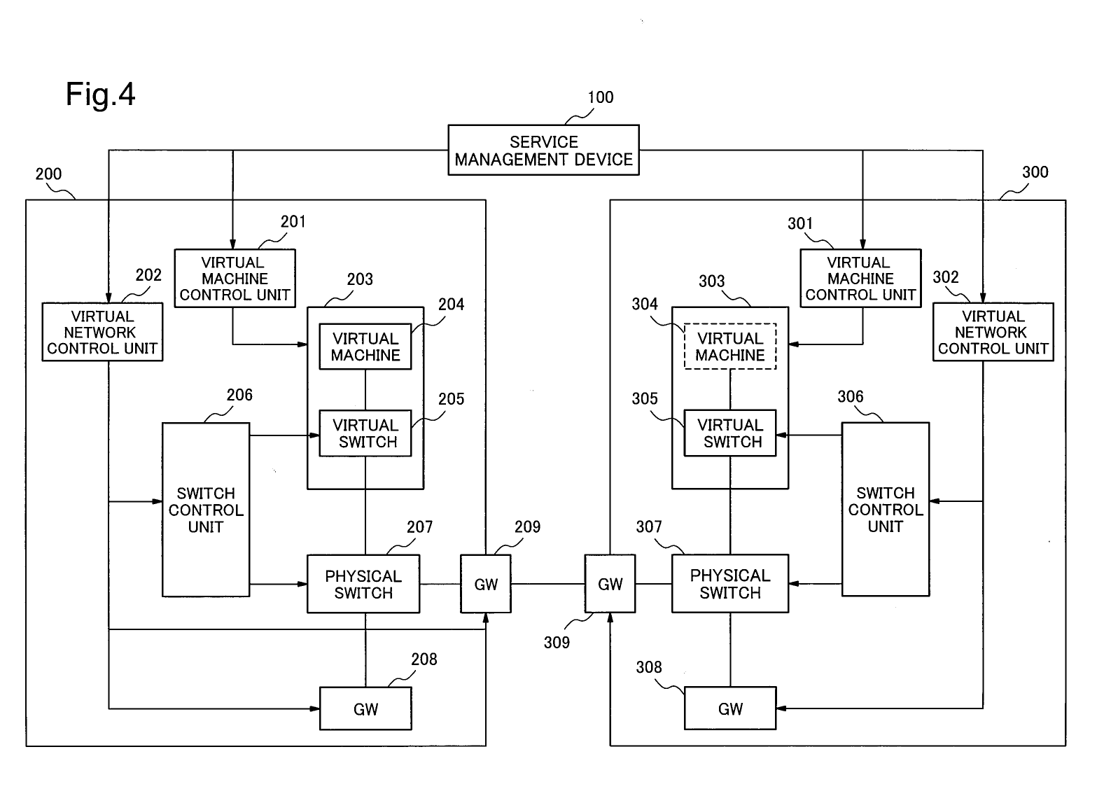

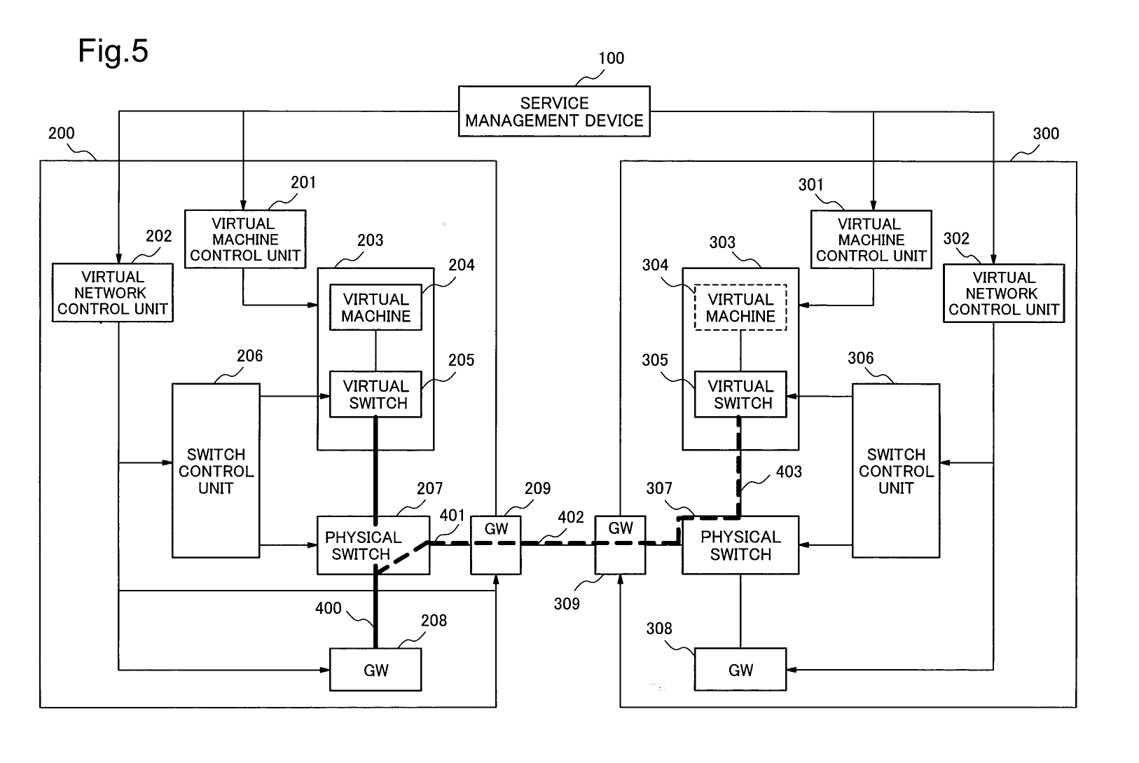

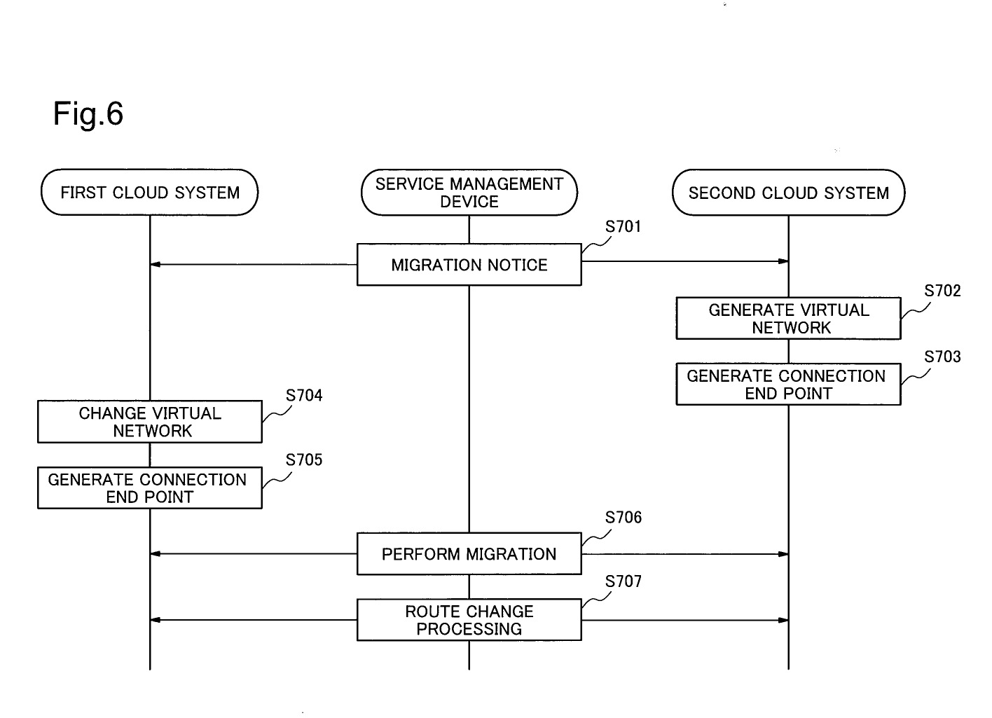

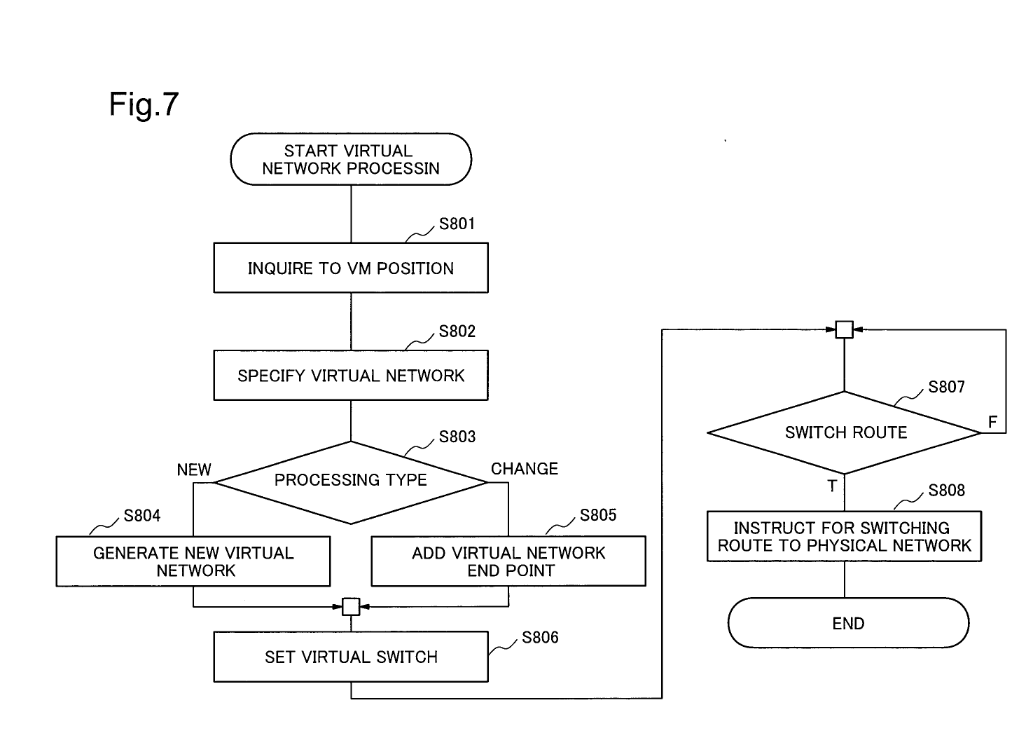

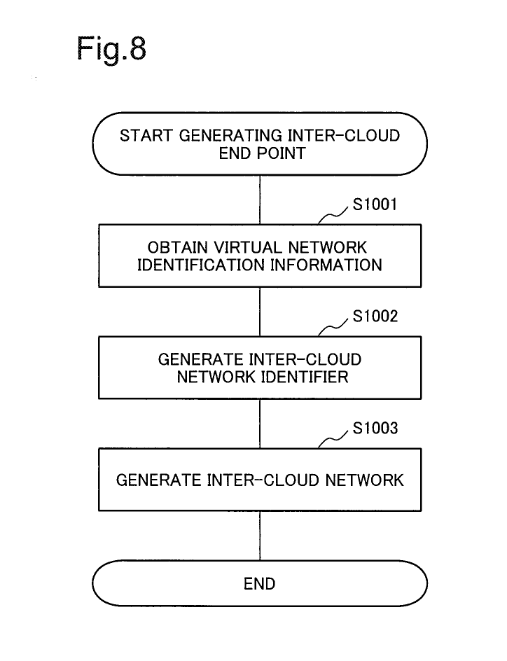

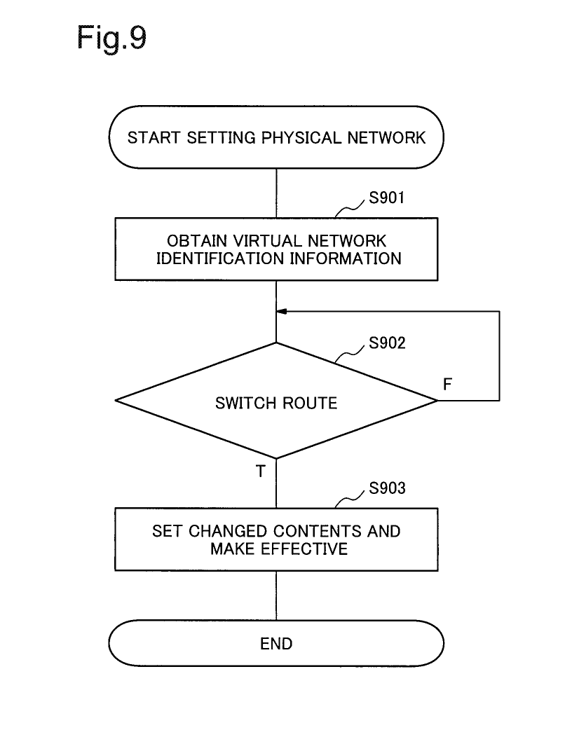

### BRIEF DESCRIPTION OF DRAWINGS

[FIG. 1] A diagram illustrating a configuration of one exemplary embodiment of the present invention;

[FIG. 2] a diagram for describing an operation of one exemplary embodiment of the present invention;

[FIG. 3] a diagram for describing an operation of one exemplary embodiment of the present invention;

[FIG. 4] a diagram illustrating an entire configuration of a system according to a first exemplary embodiment of the present invention;

[FIG. 5] a diagram illustrating change of a route before and after migration of a virtual machine according to the first exemplary embodiment of the present invention;

[FIG. 6] a sequence diagram representing an operation of the system according to the first exemplary embodiment of the present invention;

[FIG. 7] a flowchart representing a flow of a basic operation of a virtual network control unit;

[FIG. 8] a flowchart representing details of the processing performed in the steps S804 and S805 in FIG. 7;

[FIG. 9] a flowchart representing an operation of a switch control unit of the system according to the first exemplary embodiment of the present invention.

### DESCRIPTION OF EMBODIMENTS

First, an outline of one exemplary embodiment of the present invention is described with reference to the drawings. For convenience, drawing reference symbols used in this outline are attached to respective elements, as one example to facilitate understanding, and are not used for intending to limit the present invention to the illustrated embodiment.

In the one exemplary embodiment, as illustrated in FIG. 1, the present invention can be achieved by a configuration that includes a first cloud system 20, a second cloud system 30, and a service management device 10 that manages a service at the time of migration of a virtual machine between the first cloud system 20 and the second cloud system 30.

The service management device 10 includes a resource managing unit 11 that manages a resource arranged in the first cloud system 20, a resource arranged in the second cloud system 30, and a resource arranged between the first and second cloud systems 20 and 30. Further, the service management device 10 includes a migration control unit 12 that performs migration of transferring a virtual machine 22 of a user, operating on a machine of the first cloud system 20, to a machine of the second cloud system 30. Furthermore, the service management device 10 includes a route control unit 13 that changes a route of which destination or source is the virtual machine operating on the first cloud system 20 to a route of which destination or source is the virtual machine operating on the second cloud system 30 by controlling a communication node managed by the resource managing unit 11.

Description is made by citing an example in which the virtual machine operating on the first cloud system 20 is migrated to the side of the second cloud system 30. FIG. 1 illustrates a state before the migration, and a communication route of the virtual machine 22 is set as a route indicated by the both arrow line.

When a predetermined migration execution condition is established, as illustrated in FIG. 2, the migration control unit 12 instructs hypervisors 21 and 31 to perform migration. The hypervisor 31 that receives the above instruction activates a virtual machine 32 on the second cloud system 30 and prepares the migration.

Next, the route control unit 13 generates an inter-cloud network (a network between the clouds) by controlling communication nodes 23 and 33. Then, the route control unit 13 ,by using the inter-cloud network, changes a route of which destination or source is the virtual machine operating on the first cloud system 20 to a route of which destination or source is the virtual machine operating on the second cloud system 30.

Then, when the migration is performed, as illustrated in FIG. 3, the virtual machine 32 performs communication through a route indicated by the both arrow line in FIG. 3. For this reason, unlike the patent literature 1, it does not take time for route change processing. Further, occurrence of a packet loss is suppressed.

### First Embodiment

Next, an exemplary embodiment of the present invention is described with reference to the drawings in detail. FIG. 4 is a diagram illustrating an entire configuration of a system according to a first exemplary embodiment of the present invention. Referring to FIG. 4, the configuration including a service management device 100 and two tenants 200 and 300 is illustrated. “Tenant” is an execution environment (cloud environment) for a system and an application program provided for a plurality of users in a multi-tenant manner. The tenants 200 and 300 in FIG. 4 indicate cloud environments where the same user receives provision from providers of the different cloud environments.

The tenant 200 is configured so as to include a virtual machine control unit (virtual machine control means) 201, a virtual network control unit (virtual network control means) 202, a host machine 203, a switch control unit (switch control means) 206, a physical switch 207, a gateway (GW) 208 for connecting to an outside network, and a gateway (GW) 209 for interconnecting with the tenant 300.

The virtual machine control unit 201 is configured to control a virtual machine 204 operating on the host machine 203 in accordance with an instruction from a user or the service management device 100. As an example of the virtual machine control unit 201, the above-mentioned hypervisor or the like is cited.

The virtual network control unit 202 is configured to control a virtual network provided for a user by controlling the switch control unit 206, the gateway (GW) 208, and the gateway (GW) 209.

The host machine 203 is configured by equipment called a virtualizing server or the like where the virtual machine 204 and a virtual switch 205, to be used exclusively by each of a plurality of users, operate.

The switch control unit 206 controls the virtual switch 205 operating on the host machine 203, and the physical switch 207. In the following, in the present exemplary embodiment, it is assumed that the virtual switch 205 and the physical switch 207 are switches that satisfy the specification of the OpenFlow switch in the non-patent literatures 1 and 2. The switch control unit 206 controls the virtual switch 205 and the physical switch 207 by setting control information (flow entry) generated based on an instruction from the virtual network control unit 202 to the virtual switch 205 and the physical switch 207.

The gateways (GWs) 208 and 209 are configured by routers, for example.

Likewise, the tenant 300 is configured so as to include a virtual machine control unit 301, a virtual network control unit 302, a host machine 303, a switch control unit 306, a physical switch 307, a gateway (GW) 308 for connecting to an outside network, and a gateway (GW) 309 for interconnecting with the tenant 200.

In the same manner as the configuration illustrated in FIG. 1, the service management device 100 can be achieved by a configuration including a resource managing unit, a migration control unit, and a route control unit. The service management device 100 may have the same function as the OpenFlow controller in the non-patent literatures 1 and 2. Thereby, it is possible to make the service management device 100 burden a function of generating the control information (flow entry) set to the virtual switches 205 and 305 and the physical switches 207 and 307.

Each unit (processing unit) in the service management device 100 and the tenants 200 and 300 illustrated in FIG. 4 can be achieved by a computer program that causes a computer to execute each of the above-described processing by using the hardware thereof.

Next, an operation of the present exemplary embodiment is described in detail with reference to the drawings. In the following description, description is made by citing an example in which the virtual machine operating on the tenant 200 is migrated to the tenant 300, as illustrated in FIG. 5. The reference symbols 400 to 403 in FIG. 5 designate virtual networks which are targets to be controlled by the virtual network control units 202 and 302.

These virtual networks can be configured by using a tunneling technique such as GRE (Generic Routing Encapsulation) and IPinIP. However, in the present exemplary embodiment, description is made assuming that GRE is used to configure the virtual networks. In accordance with a method of a GRE protocol, encapsulation is performed so that an IP header is further added outside an IP packet generated by the virtual machines 204 and 304. As this outside IP header, an IP address of an entrance-side GRE tunnel end point as a source can be used, and an IP address of an exit-side GRE tunnel end point as a destination can be used. Accordingly, based on control information (flow entry) matching with this outside IP header, the physical switches 207 and 307 perform switching processing.

In the present exemplary embodiment, description is made assuming that the virtual networks 400 to 403 are achieved by a GRE tunnel. The virtual networks 400 to 403 are identified by UUIDs (universally unique Identifier).

FIG. 6 is a sequence diagram representing an entire operation of the system according to the first exemplary embodiment of the present invention. When migration of the virtual machine 204 is performed, the service management device 100 first starts up, via the virtual machine control unit 301, the virtual machine 304 on the host machine 303 of a migration destination and performs necessary preliminary setting (step S701). As a result of the preliminary setting, the host machine 303 of the migration destination is specified, and the physical position is fixed. Likewise, the virtual machine 204 to be migrated is also designated in the tenant 200 of a migration source, via the virtual machine control unit 201, and the host machine 203 driving the virtual machine 204 is specified.

Next, via the virtual network control units 202 and 302, the service management device 100 generates a virtual network for connecting the virtual machine 304 of the migration destination (step S702). Specifically, the virtual network 403 for connecting the virtual machine started up in the step S701 is constructed.

Next, the service management device 100 generates, in the GW 309 on the side of the tenant 300, a communication end point for a GRE tunnel of the virtual network 402 between the tenants 200 and 300 (step S703).

Next, via the virtual network control unit 202, the service management device 100 adds the setting of the virtual network 401 to the physical switch 207 constituting the virtual network 400 to which the virtual machine 204 of the migration source is connected (step S704).

Next, the service management device 100 performs addition of an end point (addition of a communication end point for the GRE tunnel) to the GW 208 and the GW 209 (step S705). By completion of the setting (end point addition) for the GW 208, GW 209, and GW 309 of the tenants 200 and 300, generation of the virtual networks 401 and 402 is completed.

Next, the service management device 100 performs the migration via the virtual machine control units 201 and 301 (step S706).

Next, via the virtual network control units 202 and 302, the service management device 100 instructs the physical switch 207 to perform route switching (step S707). Thereby, a route of a packet addressed to a user of the virtual machine 204 and the virtual machine 304 is switched from the virtual network 400 to a route passing through the virtual networks 401, 402, and 403.

Next, description is made about details of control processing for the virtual networks by the above-described virtual network control units 202 and 302. FIG. 7 is a flowchart representing a flow of a basic operation of the virtual network control units.

First, since the virtual machine which is a target to be controlled is specified by the preliminary setting of the migration in the step S701 in FIG. 6, the virtual network control units 202 and 302 inquire to the virtual machine control units 201 and 301 by using the virtual machine information (for example, an identifier or the like), and specify a position of the virtual machine (an identifier or the like of the host machine 203 where the virtual machine operates) (step S801).

Next, the virtual network control units 202 and 302 specify the virtual network to which the virtual machine which is a target to be controlled is connected (step S802).

Next, the virtual network control units 202 and 302 perform the following processing depending on whether it is necessary to generate a new virtual network or not. When a new virtual network is generated (“new” in step S803), the virtual network control units 202 and 302 generate first end points (communication end points for the GRE tunnel) in nodes to be end points of the new networks 401, 402, and 403 (step S804). Meanwhile, when the virtual network is changed (“change” in step S803), the virtual network control units 202 and 302 generate (add) second end points (communication end points for the GRE tunnel) at connection points between the tenant 200 or the tenant 300 and the existing virtual network (step S805). In this example, because the virtual networks 401, 402, and 403 illustrated in FIG. 5 are newly generated due to the migration, the first end points (the communication end points for the GRE tunnel) are generated in the GW 209, the GW 309, and the physical switch 307, respectively, and the second end points (the communication end points for the GRE tunnel) are added to the GW 208 and the virtual switch 305. Further, an IP address is set to each of these first and second end points (the communication end points for the GRE tunnel).

Here, description is made about details of the generation processing of the first and second end points (the communication end points for the GRE tunnel) by the virtual network control units 202 and 302. FIG. 8 is a flowchart representing details of the processing performed in the steps S804 and S805 in FIG. 7.

Referring to FIG. 8, the virtual network control units 202 and 302 first obtain identification information of the virtual network specified in the step S802 (step S1001). Specifically, this is performed by obtaining the allocated UUID, for example, from managing tables or the like for virtual networks held by the virtual network control units 202 and 302.

The virtual network control units 202 and 302 generate the virtual network identifier by allocating a new UUID to the virtual network to be newly generated (step S1002). Instead of the above-described UUID, an identifier or a network address for each network can also be used.

Next, the virtual network control units 202 and 302 generate the virtual network (inter-cloud network) to be switched and used after the migration by associating with the generated virtual network identifier (step S1003).

In the present exemplary embodiment, because it is assumed that the virtual network is configured by using the GRE tunnel, an IP address of a GRE tunnel end point of the GW 208 and an IP address of a GRE tunnel end point of the GW 209 are associated with the virtual network 401. Likewise, an IP address of a GRE tunnel end point of the GW 209 and an IP address of a GRE tunnel end point of the GW 309 are associated with the virtual network 402. Likewise, an IP address of a GRE tunnel end point of the GW 309 and an IP address of a GRE tunnel end point of the virtual switch 305 are associated with the virtual network 403.

Continuing description by referring to FIG. 7 again, when the virtual network control units 202 and 302 complete generation of virtual networks (inter-cloud network) to be switched and used after the migration and the migration, and determine that route switching is possible (“T” in the step S807), the virtual network control units 202 and 302 instruct the switch control units 206 and 306 to perform route switching (step S808).

FIG. 9 is a flowchart representing an operation of the switch control units 206 and 306. Referring to FIG. 9, the switch control units 206 and 306 obtain identification information for identifying individual virtual networks on a physical network from the virtual network control units 202 and 302 (step S901). As the identification information, an IP address of the GRE tunnel end point generated at the above-described step S1003, or the like can be used.

When receiving route switching instructions from the virtual network control units 202 and 302 (“T” in the step S902), the switch control units 206 and 306 set control information (flow entry) for performing route switching in the physical switches 207 and 307, and make it effective (step S903). For example, for identification of the virtual network 403, the control information (flow entry) with an IP address of the entrance-side GRE tunnel end point, an IP address of the exit-side GRE tunnel end point and the like is used as a match condition. In this entry, an action determining that a relevant packet is output from a connection port of the virtual switch 305 is set. To enable forwarding the packet to the virtual machine 304 after deleting an encapsulation header at the GRE tunnel end point of the virtual switch 305, the control information (flow entry) designating deletion of the encapsulation header and the match condition is also set in the virtual switch 305.

As described above, according to the present exemplary embodiment, in an inter-cloud base configured to extend over a plurality of cloud systems, route switching linked to migration of a virtual machine can be performed. Furthermore, according to the present exemplary embodiment, because time for route switching processing is dramatically shortened as described above, a packet loss can also be reduced.

For example, the present invention can also be applied to route switching processing at the time of migration of a virtual machine between a public cloud constructed by a cloud constructing tool of open source and a private cloud.

In the above, the exemplary embodiment of the present invention is described, however, the present invention is not limited to the above-described exemplary embodiment, and further modification, replacement, or adjustment can be applied within a range that does not depart from the basic technical idea of the present invention. For example, the network configuration and the configuration of the elements illustrated in each drawing are one example to facilitate understanding of the present invention, and the present invention is not limited to the configurations illustrated in the drawings.

Further, for example, in the above-described exemplary embodiment, description is made by using migration between the first and second tenants, however, migration from the second tenant to the first tenant can be achieved in a similar procedure, as well.

At the end, preferred embodiments of the present invention are summarized.

### First Embodiment

(Refer to the cloud-environment provision system according to the above-described first standpoint)

### Second Embodiment

The cloud-environment provision system according to first embodiment, further includes:

virtual network control means for, based on positional information of a virtual machine after the migration, generating a virtual network for forwarding a packet of which destination or source is a virtual machine operating on the first cloud system to a virtual machine after the migration; and

switch control means for controlling a switch on a route of which destination or source is a virtual machine operating on the first cloud system, so as to forward a packet of which destination is a virtual machine operating on the first cloud system to the virtual network.

### Third Embodiment

The cloud-environment provision system according to second embodiment, wherein

the virtual network control means and the switch control means are arranged in each of the first and second cloud systems.

### Fourth Embodiment

The cloud-environment provision system according to second or third embodiment, wherein

the switch control means instructs to add an additional header to a packet at an end point on an entrance-side of a virtual network, performs packet forwarding processing using the additional header, and instructs to delete the additional header at an end point on an exit-side of the virtual network.

### Fifth Embodiment

(Refer to the service management device according to the above-described second standpoint)

### Sixth Embodiment

(Refer to the route control method in a clued-environment provision system according to the above-described third standpoint)

### Seventh Embodiment

(Refer to the program according to the above-described fourth standpoint)

The fifth to seventh embodiments described above can be developed to the second to fourth embodiments as in the first embodiment.

Each disclosure of the above-mentioned patent literatures and non-patent literatures is incorporated herein by reference. Within a scope of the entire disclosure (including claims) of the present invention, the exemplary embodiments or the embodied examples can be further changed or adjusted on the basis of the basic technical idea. Within a scope of claims of the present invention, various combination or selection of the various disclosed elements (including respective elements of respective claims, respective elements of respective exemplary embodiments or embodied examples, respective elements in respective drawings, and the like) can be made. In other words, it is natural that the present invention includes various alterations and modifications that would be possible by a person skilled in the art in accordance with the entire disclosure including claims, and the technical idea. Particularly, concerning the numerical range described herein, arbitrary numerical values or small ranges included in the described range should be interpreted to be concretely described even when there is not particular description.

### REFERENCE SIGNS LIST

10, 100 Service management device

11 Resource managing unit

12 Migration control unit

13 Route control unit

20 First cloud system

21, 31 Hypervisor

22, 32, 204, 304 Virtual machine

23, 33 Communication node

30 Second cloud system

200, 300 Tenant

201, 301 Virtual machine control unit

202, 302 Virtual network control unit

203, 303 Host machine

205, 305 Virtual switch

206, 306 Switch control unit

207, 307 Physical switch

208, 209, 308, 309 Gateway (GW)

400, 401, 402, 403 Virtual network

What is claimed is:

1. A cloud-environment provision system comprising:
a resource managing unit that manages a resource arranged in a first cloud system, a resource arranged in a second cloud system, and a resource arranged between the first and second cloud systems;
a migration control unit that performs migration of transferring a virtual machine of a user operating on a machine in the first cloud system to a machine in the second cloud system; and
a route control unit that, after the migration is performed, changes a route of which destination or source is a virtual machine operating on the first cloud system to a route of which destination or source is a virtual machine operating on the second cloud system by controlling a communication node managed by the resource managing unit.

2. The cloud-environment provision system according to claim 1, further comprising:
a virtual network control unit that, based on positional information of a virtual machine after the migration, generates a virtual network for forwarding a packet of which destination or source is a virtual machine operating on the first cloud system to a virtual machine after the migration; and
a switch control unit that controls a switch on a route of which destination or source is a virtual machine operating on the first cloud system, so as to forward a packet of which destination is a virtual machine operating on the first cloud system to the virtual network.

3. The cloud-environment provision system according to claim 2, wherein
the virtual network control unit and the switch control unit are arranged in each of the first and second cloud systems.

4. The cloud-environment provision system according to claim 2, wherein
the switch control unit instructs to add an additional header to a packet at an end point on an entrance-side of a virtual network, performs packet forwarding processing using the additional header, and instructs to delete the additional header at an end point on an exit-side of the virtual network.

5. (canceled)

6. A route control method for a service management device in a cloud-environment provision system comprising:
managing a resource arranged in a first cloud system, a resource arranged in a second cloud system, and a resource arranged between the first and second cloud systems;
performing migration of transferring a virtual machine of a user operating on a machine in the first cloud system to a machine in the second cloud system; and
changing a route of which destination or source is a virtual machine operating on the first cloud system to a route of which destination or source is a virtual machine operating on the second cloud system.

7. A computer readable non-transitory medium embodying a program, the program causing a computer constituting a service management device to perform a method, the method comprising:
managing a resource arranged in a first cloud system, a resource arranged in a second cloud system, and a resource arranged between the first and second cloud systems;
performing migration of transferring a virtual machine of a user operating on a machine in the first cloud system to a machine in the second cloud system; and
changing a route of which destination or source is a virtual machine operating on the first cloud system to a route of which destination or source is a virtual machine operating on the second cloud system.
